(19) United States
(12) Patent Application Publication
(10) Pub. No.: US 2025/0190501 A1
(43) Pub. Date: Jun. 12, 2025

(54) CONTENT MANAGEMENT SYSTEM PLUGIN FOR A LARGE LANGUAGE MODEL

(71) Applicant: Dropbox, Inc., San Francisco, CA (US)

(72) Inventors: Pardhu Konakanchi, New York, NY (US); Andrew Lawson, Santa Rosa, CA (US); Aidan Lloyd-Tucker, Portola Valley, CA (US); John Maschmeyer, St Louis, MO (US); Kevin Kannammalil, Toronto (CA); Mathew Baltes, Santa Monica, CA (US); Pranay Sowdaboina, Sunnyvale, CA (US); Roland Hui, Bellevue, WA (US); Vidit Bhargava, New York, NY (US)

(21) Appl. No.: 18/537,073

(22) Filed: Dec. 12, 2023

(51) Int. Cl. G06F 16/9532; G06F 16/958; G06F 40/40

(52) U.S. Cl. CPC G06F 16/9532; G06F 16/958; G06F 40/40

(57) ABSTRACT

The present disclosure relates to systems, non-transitory computer-readable media, and methods for integrating a content management system plugin with a large language model. In particular, in some embodiments, the disclosed systems integrate, into a computing environment of a large language model, a content management system plugin comprising computer code for an application programming interface (API) that facilitates operations by the large language model on content items stored in a content management system. Moreover, in some embodiments, the disclosed systems receive, from the large language model via the content management system plugin, a function call requesting performance of an API operation on a content item stored in the content management system. Furthermore, in some implementations, the disclosed systems execute the API operation on the content item stored in the content management system in response to the function call from the content management system plugin integrated within the large language model.

### BACKGROUND

Advancements in computing platforms have given rise to a variety of innovations for generative language models. For example, existing language models can provide natural language responses to user queries. Despite advances from these innovations, however, existing systems continue to suffer from a number of disadvantages.

For instance, existing language models often lack capability to generate query responses based on user-specific data. For example, existing systems may utilize artificial intelligence to produce a query response based on publicly available information from databases or websites accessible via a network, but generally do not utilize user-account-specific content to inform the query response. As another example, existing systems employing language models often are limited to using information seen during training of the models.

As a result of their inability to integrate content from specific user accounts, many existing systems are inflexible. In particular, some existing systems are rigidly fixed to generating responses based on public network data, and such systems cannot adapt on a user-account-specific basis to generate responses tailored to content of user accounts within a content management system. Rather, the responses generated by existing systems are customized for user accounts only insofar as the specific queries entered by user accounts are customized.

These along with additional problems and drawbacks exist with regard to existing language model systems.

### BRIEF SUMMARY

Embodiments of the present disclosure provide benefits and/or solve one or more of the foregoing or other problems in the art with systems, non-transitory computer-readable media, and methods for integrating a content management system plugin with a large language model. For example, in some embodiments, the disclosed systems integrate, with a large language model, a content management system plugin that includes application programming interface (API) functionality for the large language model to interact directly with content items stored on a content management system. To illustrate, in some implementations, the disclosed systems transmit a large language model prompt to the large language model with instructions to utilize the content items to generate a result for the large language model prompt. Additionally, the disclosed systems can receive one or more function calls from the large language model via the content management system plugin. In some embodiments, a function call requests performance of an API operation on one or more content items stored in the content management system. The disclosed systems can execute the API operation on the one or more content items and provide an output, such as a modified content item or a new content item, to the large language model for additional analysis. In some cases, the disclosed systems provide the result for the large language model prompt to a user device, such as a display via a user interface and/or an upload of a new or modified content item to the content management system.

The following description sets forth additional features and advantages of one or more embodiments of the disclosed methods, non-transitory computer-readable media, and systems. In some cases, such features and advantages are evident to a skilled artisan having the benefit of this disclosure, or may be learned by the practice of the disclosed embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a plugin integration system operates in accordance with one or more embodiments.

FIG. 2 illustrates an overview of the plugin integration system integrating a content management system plugin with a large language model in accordance with one or more embodiments.

FIG. 3 illustrates operations of the plugin integration system in conjunction with a large language model in accordance with one or more embodiments.

FIG. 4 illustrates the plugin integration system executing a layered set of API operations in accordance with one or more embodiments.

FIG. 5 illustrates the plugin integration system providing a user interface element for initiating a large language model prompt in accordance with one or more embodiments.

FIG. 6 illustrates the plugin integration system providing a user interface element for initiating a large language model prompt in accordance with one or more embodiments.

FIG. 7 illustrates the plugin integration system interfacing with a large language model to generate responses to prompts in accordance with one or more embodiments.

FIG. 8 illustrates a flowchart of a series of acts for integrating and utilizing a content management system plugin with a large language model in accordance with one or more embodiments.

FIG. 9 illustrates a block diagram of an example computing device for implementing one or more embodiments of the present disclosure.

FIG. 10 illustrates a network environment of a content management system in accordance with one or more embodiments.

### DETAILED DESCRIPTION

This disclosure describes one or more embodiments of a plugin integration system that utilizes a content management system plugin for a large language model to provide an interface for the large language model to interact with content items within a content management system. To illustrate, the plugin integration system can integrate the content management system plugin with the large language model. The content management system plugin can include application programming interface (API) functionality for the large language model to interact with content items on the content management system. For example, the plugin integration system can send a large language model prompt to the large language model with instructions to utilize the content items to generate a result for the large language model prompt. Utilizing the content management system plugin, the large language model can respond to the prompt by interacting with the content items. For instance, the plugin integration system can receive one or more function calls from the large language model via the content management system plugin. The function call can request performance of an API operation on one or more content items stored in the content management system. The plugin integration system can execute the API operation on the one or more content items and provide an output, such as a modified content item or a new content item, to the large language model for additional analysis. Additionally, the plugin integration system can upload a modified content item or a new content item to the content management system.

Additionally, and as described in greater detail below, the plugin integration system can utilize the large language model, via the content management system plugin, to execute a layered set of API operations on the content items within the content management system. For instance, the large language model may determine certain API operations to perform in order. The plugin integration system can collaborate with the large language model to provide the large language model with access to content items for a variety of interactions using API operations from the content management system and/or API operations from third-party systems. For example, the plugin integration system can (using API operations called by a large language model) download content items from the content management system, provide metadata for content items, generate new content items, modify existing content items, upload new or modified content items, and/or share content items with other systems.

The plugin integration system provides a variety of technical advantages relative to existing systems. For example, by integrating the content management system plugin with a large language model, the plugin integration system provides new functionality to the large language model unavailable in prior systems. In particular, the plugin integration system provides a specially designed plugin whereby the large language model can access, interact with, retrieve information from, and/or modify content items within a content management system. For instance, the plugin integration system provides the large language model with access to user-specific content within a repository controlled by a private user account. Thus, the plugin integration system renders the large language model more versatile by expanding the domain of information from which the large language model can borrow. More particularly, the plugin integration system allows a user account of a content management system to query the large language model with instructions to perform operations on user-specific content items, thereby allowing the large language model to flexibly adapt and tailor results for prompts to the user account (for example, above and beyond merely accessing widely available web content).

As illustrated by the foregoing discussion, the present disclosure utilizes a variety of terms to describe features and advantages of the plugin integration system. Additional detail is hereafter provided regarding the meaning of these terms as used in this disclosure. For example, as used herein, the term “digital content item” (or “content item”) refers to a digital object or a digital file that includes information interpretable by a computing device (e.g., a client device) to present information to a user. A content item can include a file or a folder such as a digital text file, a digital image file, a digital audio file, a webpage, a website, a digital video file, a web file, a link, a hyperlinked video file streamable from a webpage, a calendar event, a task, a to-do list, a contact card, a text message thread, a direct message thread, a chat group thread, a social media feed, a social media post, a news article, a headline, a technical support ticket, a digital document file, or some other type of file or digital object. A content item can have a particular file type or file format, which may differ for different types of content items (e.g., digital documents, digital images, digital videos, or digital audio files, etc.). In some cases, a content item can refer to a remotely stored (e.g., cloud-based) item or a link (e.g., a link or reference to a cloud-based content item or a web-based content item). A content item can include a content clip that indicates, links, and/or references a discrete selection or segmented sub-portion of content from a larger content item. For example, a content item can be a clipped portion of a webpage, audio recording transcript, videoconference recording transcript, or other content item or source. A content item can be editable or otherwise modifiable and can also be sharable from one user account (or client device) to another. In some cases, a content item is modifiable by multiple user accounts (or client devices) simultaneously and/or at different times. Additionally, a content item can include metadata associated with another content item.

Additionally, as used herein, the term “API operation” refers to a process (or a combination of processes) for performing a function (e.g., a transformation of a content item) called via an API. For example, an API operation is callable by external systems/computers to perform the function on the content item. In some cases, an API operation is native to, and executed by, a content management system (e.g., performable by the content management system on a content item stored within the content management system). In other cases, an API operation is provided by a third-party system to be performed on a content item at the third-party system or at the content management system.

Relatedly, as used herein, the term “layered API routine” refers to a set of multiple API operations. For example, the term “layered API routine” includes an ordered series of API operations to be executed in sequence. To illustrate, a layered API routine can include a sequence of API operations where each successive API operation builds on the output from the previous API operation interacting with one or more content items stored on a content management system.

Moreover, as used herein, the term “content management system plugin” refers to computer code that includes, or can call, API operations for one or more content items stored within a content management system. For example, a content management system plugin includes executable code that can be installed at an external system to interface the external system with the content management system. In particular, the external system can utilize the content management system plugin to make a function call to the content management system requesting execution of an API operation on a content item.

As used herein, the term “machine learning model” refers to a computer representation that is tunable (e.g., trained) based on inputs to approximate unknown functions used for generating corresponding outputs. In particular, a machine learning model can include a computer-implemented model that utilizes algorithms to learn from, and make predictions on, known data by analyzing the known data to learn to generate outputs that reflect patterns and attributes of the known data. For instance, a machine learning model can include, but is not limited to, a neural network (e.g., a convolutional neural network, recurrent neural network, or other deep learning network), a decision tree (e.g., a gradient boosted decision tree), support vector learning, Bayesian networks, a transformer-based model, a diffusion model, or a combination thereof. In some embodiments, the plugin integration system utilizes a machine learning model in the form of a large language neural network.

Similarly, as used herein, the term “neural network” refers to a set of one or more machine learning models that can be trained and/or tuned based on inputs to determine classifications and/or scores, or to approximate unknown functions. For example, a neural network can include a model of interconnected artificial neurons (e.g., organized in layers) that communicate and learn to approximate complex functions and generate outputs based on inputs provided to the neural network. In some cases, a neural network refers to an algorithm (or set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a diffusion neural network, a recurrent neural network (e.g., an LSTM), a graph neural network, a transformer, or a generative adversarial neural network. Upon training, a neural network may become a large language model.

Relatedly, as used herein, the term “large language model” refers to a set of one or more machine learning models trained to perform computer tasks to generate or identify computing code and/or data in response to trigger events (e.g., user interactions, such as text queries and button selections). In particular, a large language model can be a neural network (e.g., a deep neural network) with many parameters trained on large quantities of data (e.g., unlabeled text) using a particular learning technique (e.g., self-supervised learning). For example, a large language model can include parameters trained to generate or identify computing code and/or data based on various contextual data, including information from historical user account behavior.

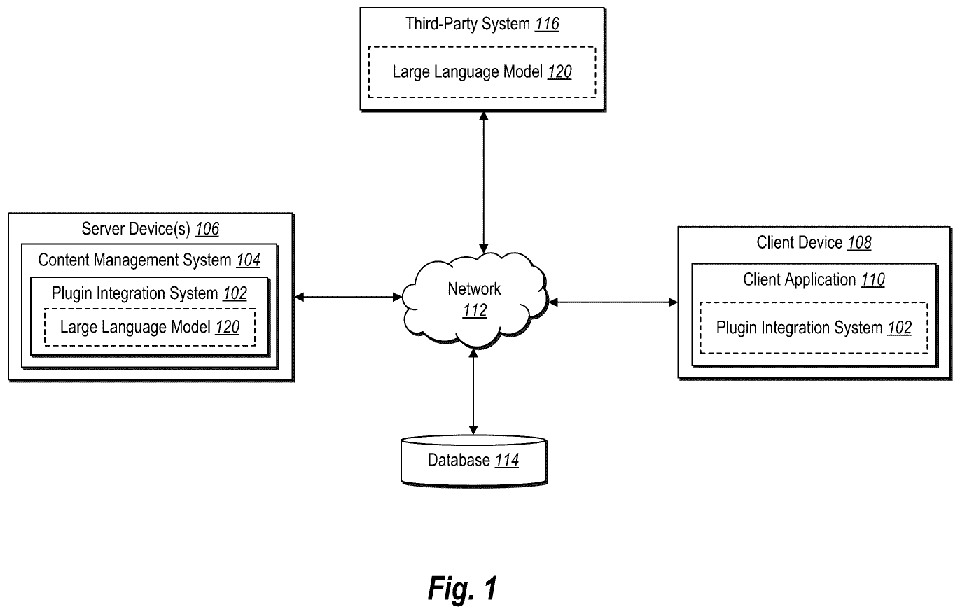

Additional detail regarding the plugin integration system will now be provided with reference to the figures. For example, FIG. 1 illustrates a schematic diagram of an example system environment for implementing a plugin integration system 102 in accordance with one or more implementations. An overview of the plugin integration system 102 is described in relation to FIG. 1. Thereafter, a more detailed description of the components and processes of the plugin integration system 102 is provided in relation to the subsequent figures.

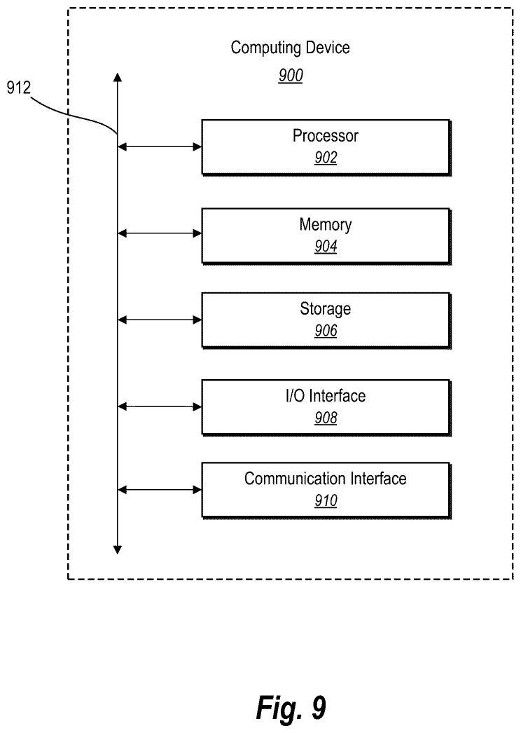

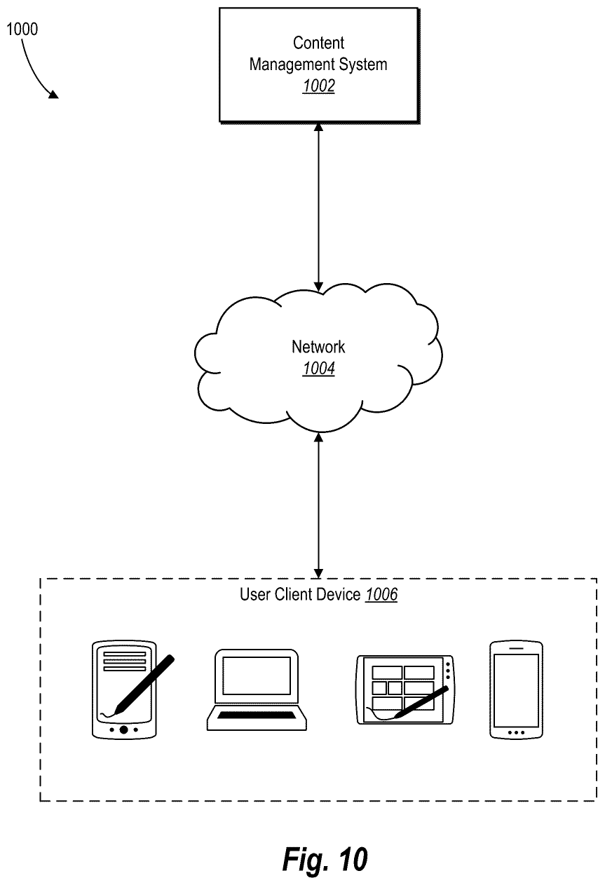

As shown, the environment includes server device(s) 106, a client device 108, a database 114, a third-party system 116, and a network 112. Each of the components of the environment can communicate via the network 112, and the network 112 may be any suitable network over which computing devices can communicate. Example networks are discussed in more detail below in relation to FIGS. 9-10.

As mentioned above, the example environment includes client device 108. The client device 108 can be one of a variety of computing devices, including a smartphone, a tablet, a smart television, a desktop computer, a laptop computer, a virtual reality device, an augmented reality device, or another computing device as described in relation to FIGS. 9-10. The client device 108 can communicate with the server device(s) 106, the third-party system 116, and/or the database 114 via the network 112. For example, the client device 108 can receive user input from a user interacting with the client device 108 (e.g., via a client application 110) to, for instance, integrate a content management system plugin with a large language model 120, interact with one or more content items, collaborate with a co-user of a different client device, and/or select a user interface element. In addition, the plugin integration system 102 on the server device(s) 106 can receive information relating to a plugin integration request, various interactions with content items, and/or interactions with user interface elements based on the input received by the client device 108 (e.g., to integrate the content management system plugin with the large language model 120, access content items, and/or perform some other action).

As shown, the client device 108 can include a client application 110. In particular, the client application 110 may be a web application, a native application installed on the client device 108 (e.g., a mobile application, a desktop application, etc.), or a cloud-based application where all or part of the functionality is performed by the server device(s) 106. Based on instructions from the client application 110, the client device 108 can present or display information, including an interface for interacting with content items (e.g., via embedded applications) from a content management system 104 or from other network locations.

As illustrated in FIG. 1, the example environment also includes the server device(s) 106. The server device(s) 106 may generate, track, store, process, receive, and/or transmit electronic data, such as digital content items, interface elements, plugin integration requests, interactions with digital content items, interactions with interface elements, and/or interactions between user accounts or client devices. For example, the server device(s) 106 may receive data from the client device 108 in the form of a plugin integration request to integrate a content management system plugin with the large language model 120, generate or retrieve a particular content item, and/or perform some other act in support of the plugin integration request. In addition, the server device(s) 106 can transmit data to the client device 108 in the form of an interface that includes one or more content items related to operations performed by the large language model. Indeed, the server device(s) 106 can communicate with the client device 108 to send and/or receive data via the network 112. In some implementations, the server device(s) 106 comprises a distributed server where the server device(s) 106 includes a number of server devices distributed across the network 112 and located in different physical locations. The server device(s) 106 can comprise one or more content servers, application servers, communication servers, web-hosting servers, machine learning servers, and/or other types of servers.

As shown in FIG. 1, the server device(s) 106 can also include the plugin integration system 102 as part of content management system 104. The content management system 104 can communicate with the client device 108 to perform various functions associated with the client application 110 such as managing user accounts, managing content collections, managing content items, and facilitating user interaction with the content collections and/or content items. Indeed, the content management system 104 can include a network-based smart cloud storage system to manage, store, and maintain content items and related data across numerous user accounts, including user accounts in collaboration with one another. In some embodiments, the plugin integration system 102 and/or the content management system 104 utilize the database 114 to store and access information such as digital content items.

As also illustrated in FIG. 1, the plugin integration system 102 can include large language model 120. In particular, the plugin integration system 102 can utilize the large language model 120 integrated with (e.g., in communication with, responsive to, trained by data from, etc.) the content management system 104. For example, the plugin integration system 102 can store or encode relationship information to define relationships between user accounts and content items within the content management system 104 (and/or housed at other server locations). The large language model 120 can send function calls to the plugin integration system 102 to access the relationship information and/or interact with the content items stored within the content management system 104. Moreover, the large language model 120 can provide to the client device 108 (e.g., via the plugin integration system 102) results of operations on the content items in response to a user interaction via an interface. For instance, the large language model 120 can access, generate, modify, and/or share a content item associated with a user account based on an input prompt received from the client device 108.

FIG. 1 further illustrates a third-party system 116. In particular, the third-party system 116 can host or house the large language model 120 (e.g., as an alternative to the server device(s) 106 hosting or housing the large language model 120) for access by the plugin integration system 102. For example, the third-party system 116 can include a server location hosting the large language model 120 that is external to the plugin integration system 102. In some cases, the third-party system 116 is external to the plugin integration system 102, but the plugin integration system 102 can nevertheless access and utilize the large language model 120 to integrate a content management system plugin with the large language model 120 and/or to perform operations on content items within the content management system 104.

Moreover, in some implementations, the plugin integration system 102 and/or the large language model 120 interacts with one or more additional third-party systems (e.g., beyond the third-party system 116 that can house the large language model 120). For example, in some implementations, the plugin integration system 102 and/or the large language model 120 communicates with one or more third-party systems to receive third-party function calls requesting performance of third-party API operations on content items stored in the content management system 104.

Although FIG. 1 depicts the plugin integration system 102 located on the server device(s) 106, in some implementations, the plugin integration system 102 may be implemented by (e.g., located entirely, or in part, on) one or more other components of the environment. For example, the plugin integration system 102 may be implemented by the client device 108, and/or a third-party device. For example, the client device 108 can download all or part of the plugin integration system 102 for implementation independent of, or together with, the server device(s) 106. As another example, the third-party system 116 can download all or part of the plugin integration system 102 for implementation independent of, or together with, the server device(s) 106.

In some implementations, the environment may have a different arrangement of components and/or may have a different number or set of components altogether. For example, the client device 108 may communicate directly with the plugin integration system 102 on the server device(s) 106, bypassing the network 112. As another example, the environment can include the database 114 located external to the server device(s) 106 (e.g., in communication via the network 112) or located on the server device(s) 106, on the third-party system 116, and/or on the client device 108.

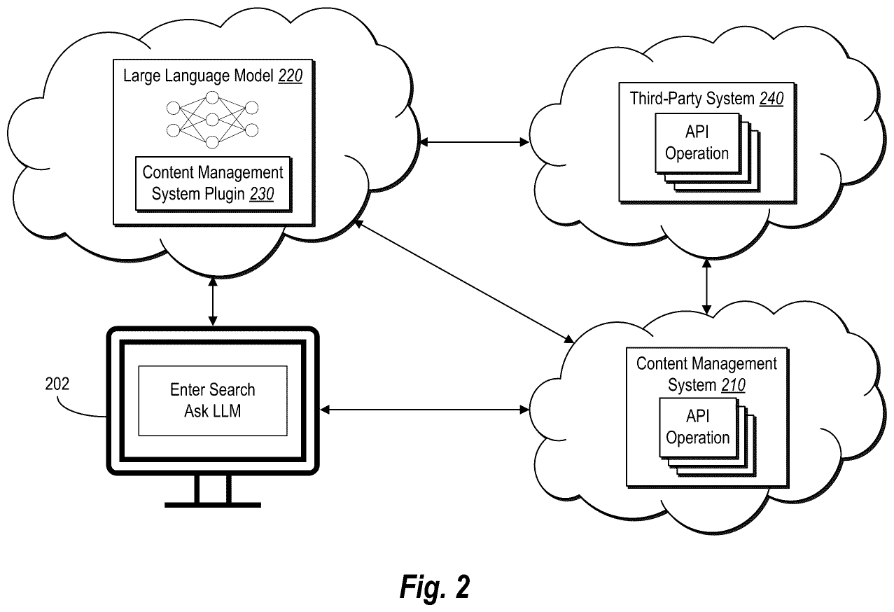

As discussed, in some implementations, the plugin integration system 102 facilitates operations by a large language model on content items stored in a content management system. For instance, FIG. 2 illustrates an overview of the plugin integration system 102 integrating a content management system plugin with a large language model in accordance with one or more embodiments.

To illustrate, in some embodiments, the plugin integration system 102 integrates a content management system plugin 230 into a computing environment of a large language model 220 (e.g., the large language model 120). For example, the content management system plugin 230 includes computer code for an application programming interface (API) that facilitates operations by the large language model 220 on content items stored in content management system 210 (e.g., the content management system 104). For instance, the plugin integration system 102 sends and/or installs the computer code within the computing environment of (e.g., network servers hosting) the large language model 220 to make available one or more API operations to the large language model 220.

In addition, in some embodiments, the plugin integration system 102 receives a function call requesting performance of an API operation on a content item stored in the content management system 210. For example, the plugin integration system 102 receives the function call from the large language model 220 via the content management system plugin 230. As described in additional detail below, the plugin integration system 102 can receive numerous different types of function calls from the large language model 220. In some embodiments, the plugin integration system 102 performs a layered set of API operations in response to the function calls.

As mentioned, in some implementations, the plugin integration system 102 executes the API operation (or the layered set of API operations) on the content item stored in the content management system 210. For example, in response to the function call from the content management system plugin 230 integrated within the large language model 220, the plugin integration system 102 performs the API operation. Stated differently, the plugin integration system 102 executes the API operation on the content item in response to the function call from the large language model 220 via the content management system plugin 230.

Moreover, in some implementations, the plugin integration system 102 utilizes a client device 202 (e.g., the client device 108) to obtain a prompt that requests that the large language model 220 interact with content items stored on the content management system 210. For instance, the plugin integration system 102 can provide a selectable element via a user interface of the client device 202 for entering a prompt for the large language model 220.

Additionally, the plugin integration system 102 can receive and execute API operations from a third-party system 240. For example, the large language model 220 may determine to perform one or more third-party API operations on the content item(s) stored in the content management system 210. In some embodiments, the plugin integration system 102 performs the third-party API operation upon receiving executable instructions defining the third-party operation. In some embodiments, the third-party system 240 performs the third-party API operations and transmits the results (e.g., a content item modified by execution of the third-party API operation) to the plugin integration system 102 and/or the large language model 220.

Furthermore, the plugin integration system 102 can perform team-based API operations. To illustrate, the plugin integration system 102 executes a team-based API operation on a plurality of content items stored across a plurality of user accounts of the content management system 210. For example, the plugin integration system 102 executes a team-based API operation on a first content item stored for a first user account of the content management system 210, and executes the team-based API operation on a second content item stored for a second user account of the content management system 210.

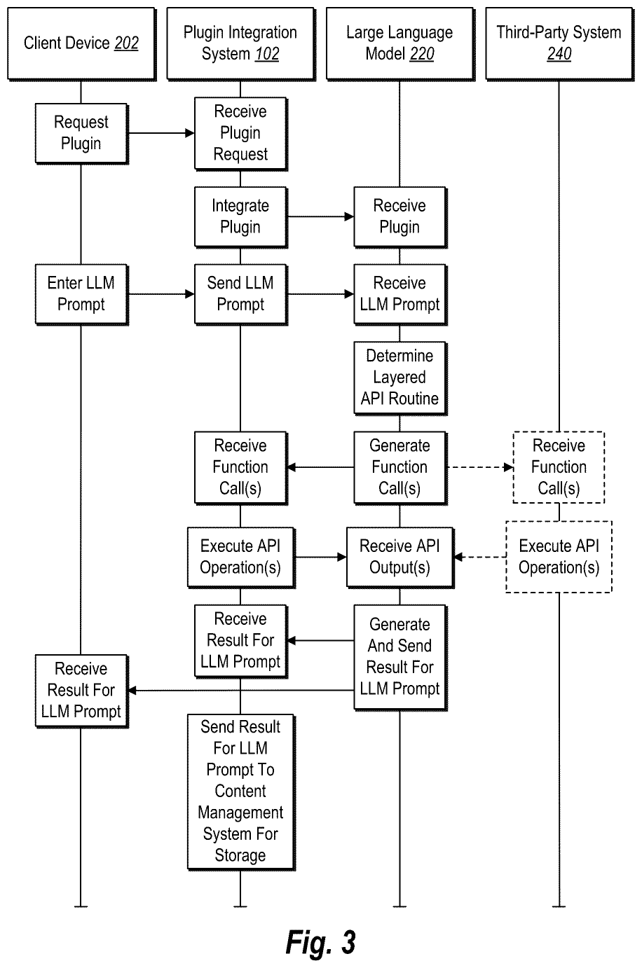

As discussed, in some embodiments, the plugin integration system 102 performs operations to integrate a content management system plugin with a large language model and execute API operations for the large language model. For instance, FIG. 3 illustrates operations of the plugin integration system 102 in conjunction with a large language model in accordance with one or more embodiments.

Specifically, FIG. 3 shows the plugin integration system 102 interacting with the large language model 220, the client device 202, and the third-party system 240. For example, the client device requests (e.g., based on a user input) that the plugin integration system 102 integrate a content management system plugin with the large language model 220, and the plugin integration system 102 receives the request to integrate the content management system plugin. To illustrate, based on a user input to have the large language model 220 interact with content items on a content management system, the plugin integration system 102 receives a request to install the content management system plugin into a computing environment of the large language model 220.

As mentioned, in some embodiments, the plugin integration system 102 integrates the content management system plugin with the large language model 220. For instance, the plugin integration system 102 sends the content management system plugin to the large language model 220 with instructions to install the content management system plugin. In response, the large language model 220 receives the content management system plugin and incorporates the content management system plugin into the computing environment (e.g., by installing computer code defining the content management system plugin on network servers hosting the large language model 220). Utilizing the content management system plugin, the large language model 220 identifies one or more API operations defined by the content management system plugin to utilize with content items in the content management system.

Moreover, in some implementations, the plugin integration system 102 informs the client device 202 that the content management system plugin is integrated with the large language model 220. The client device 202 can transmit a large language model prompt to the plugin integration system 102. In turn, the plugin integration system 102 can transmit the large language model prompt to the large language model 220, and the large language model 220 receives the large language model prompt from the plugin integration system 102.

In addition, the large language model 220 processes the large language model prompt in accordance with the content management system plugin. For example, the large language model 220 determines a layered API routine for one or more content items in the content management system. For instance, the large language model 220 determines that certain API operations would assist the large language model 220 to provide an answer to and/or generate a content item in response to the large language model prompt. To illustrate an example, the large language model 220 determines that the layered API routine includes an access API operation, a modify API operation, a generate API operation, and a share API operation.

In some implementations, the large language model 220 generates one or more function calls requesting performance of the one or more API operations (e.g., one function call per API operation) by the plugin integration system 102. The plugin integration system 102 can receive the one or more function calls from the large language model 220 via the content management system plugin. Continuing the previous example, the plugin integration system 102 receives the access API operation, the modify API operation, the generate API operation, and the share API operation from the large language model 220 via the content management system plugin.

Moreover, the plugin integration system 102 can execute the one or more API operations on content items stored in the content management system. Again continuing the previous example, the plugin integration system 102 executes the access API operation by providing access to metadata of a content item (or access to full file or folder information for the content item) to the large language model 220. Additionally, the plugin integration system 102 executes the modify API operation by generating a modification or edit to the content item. Moreover, the plugin integration system 102 executes the generate API operation by generating a new content item (e.g., containing the modification or edit). Furthermore, the plugin integration system 102 executes the share API operation by sharing the new content item with the large language model 220. These examples are illustrative only, and the plugin integration system 102 can execute additional API operations and/or altered versions of these API operations, as described in further detail below.

In some embodiments, as further illustrated in FIG. 3, the large language model 220 also sends (optionally) one or more function calls to the third-party system 240. For example, the large language model 220 may determine to perform a third-party API operation on a content item from the content management system. The third-party system 240 receives the one or more function calls requesting performance of one or more API operations on the content item.

Additionally, the third-party system 240 can execute the one or more API operations on the content item. For example, the third-party system 240 may be capable of performing a special effect, such as a video editing technique on the content item. The third-party system 240 can execute a video editing API operation on the content item and return an edited version of the content item to the large language model 220 and/or the plugin integration system 102.

In some embodiments, the plugin integration system 102 executes the third-party API operation. For example, the plugin integration system 102 receives (e.g., via the content management system plugin) computer code defining the third-party API operation. The plugin integration system 102 can perform the third-party API operation on a content item in the content management system.

Moreover, the plugin integration system 102 can perform additional API operations on content items edited by the third-party system 240. For instance, the plugin integration system 102 can receive an additional function call from the large language model 220 via the content management system plugin (or directly from the third-party system 240). The additional function call can request performance of an additional API operation on a content item after the content item is modified by execution of a third-party API operation at the third-party system 240. The plugin integration system 102 can execute the additional API operation on the content item in response to the additional function call.

Furthermore, in some implementations, the large language model 220 receives outputs of the one or more API operations from the plugin integration system 102 and (optionally) the third-party system 240. To illustrate, the large language model 220 receives copies of content items stored in the content management system, modified content items, and/or new content items based on the one or more API operations.

In some implementations, the large language model 220 performs additional operations (e.g., analysis, search, etc.) on the content items, modified content items, and/or new content items in furtherance of answering the large language model prompt from the plugin integration system 102. For instance, the large language model 220 can generate a result (e.g., a copy of a new or modified content item) for the large language model prompt based on the interactions with the one or more content items. The large language model 220 can send the result for the large language model prompt to the plugin integration system 102 and/or the client device 202.

In turn, the plugin integration system 102 can receive the result for the large language model prompt from the large language model 220. In some implementations, the plugin integration system 102 provides the result for display via a user interface of the client device 202 (e.g., in place of the large language model 220 sending the result to the client device 202).

Consequently, in some embodiments, the client device 202 receives the result for the large language model prompt. For example, the client device 202 receives the result from the plugin integration system 102. In some cases, the client device 202 receives the result from the large language model 220.

Furthermore, in some implementations, the plugin integration system 102 sends the result for the large language model prompt to the content management system. For example, the plugin integration system 102 stores a copy of a new or modified content item in the content management system.

As previously explained, the plugin integration system 102 can execute multiple API operations (e.g., in a sequence where each operation builds on the output from the previous operation interacting with content stored on the content management system), including repeating API operations. For instance, the plugin integration system 102 can receive an additional function call (e.g., after receiving an initial function call) from the large language model 220 via the content management system plugin. The additional function call can request performance of an additional API operation on the content item stored in the content management system. Moreover, the plugin integration system 102 can execute the additional API operation on the content item in response to the additional function call.

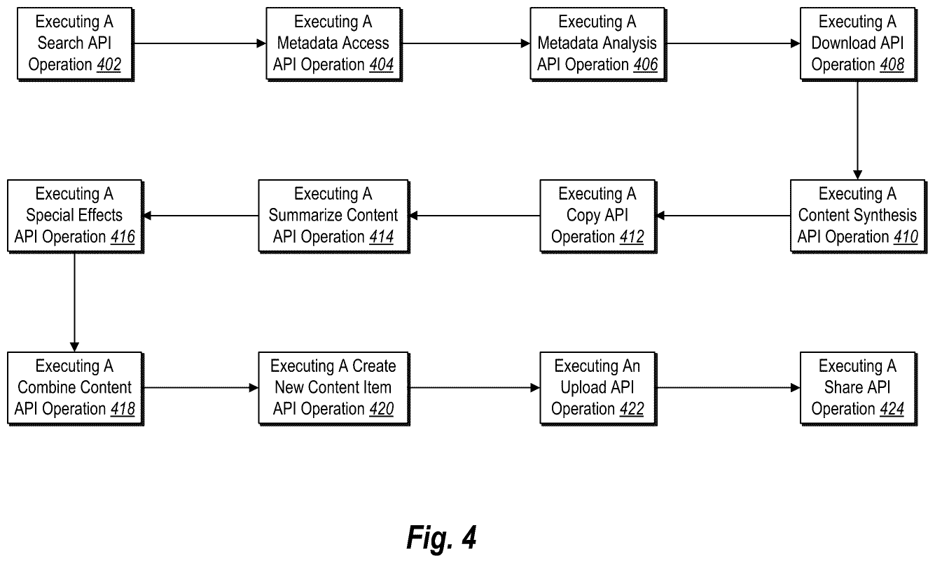

As discussed above, in some embodiments, the plugin integration system 102 performs one or more API operations in furtherance of a large language model prompt. For instance, FIG. 4 illustrates the plugin integration system 102 executing a layered set of API operations in accordance with one or more embodiments.

For example, in some implementations, the plugin integration system 102 receives (e.g., from a large language model via the content management system plugin) function calls requesting performance of an ordered series of API operations on one or more content items stored in the content management system. As detailed further with the examples below, the plugin integration system 102 can execute the ordered series of API operations on the one or more content items in response to the function calls. The following paragraphs describe an example use case in which the plugin integration system 102 receives a prompt to generate and share a summary document for quarterly revenues of a company. For instance, a user enters a prompt into a client device “get quarterly revenue info and prepare a summary pdf.” The user can indicate that the plugin integration system 102 should use the large language model to prepare the document. Example operations of the plugin integration system 102 follow.

In particular, FIG. 4 shows the plugin integration system 102 performing an act 402 of executing a search API operation. For example, in response to a function call (which the large language model generates based on the prompt) from the large language model via the content management system plugin, the plugin integration system 102 searches through content items stored within the content management system. To illustrate, the plugin integration system 102 searches for content items stored in the content management system that contain revenue information for the quarter.

In addition, FIG. 4 shows the plugin integration system 102 performing an act 404 of executing a metadata access API operation. For example, in response to a function call from the large language model via the content management system plugin, the plugin integration system 102 provides metadata for one or more content items to the large language model. For instance, the plugin integration system 102 transmits metadata for a file or folder within the content management system to the large language model. To illustrate, the plugin integration system 102 provides the metadata (e.g., file names, folder names, etc.) of the content items that contain revenue information.

Furthermore, FIG. 4 shows the plugin integration system 102 performing an act 406 of executing a metadata analysis API operation. For example, in response to a function call from the large language model via the content management system plugin, the plugin integration system 102 analyzes metadata of one or more content items. For instance, the plugin integration system 102 analyzes a file name, a folder name, a creation data, an author name, and/or other metadata to determine one or more content items for a download call. To illustrate, the plugin integration system 102 can analyze the metadata of the content items that contain revenue information, and determine which of the content items have useful information for preparing the summary document.

Moreover, FIG. 4 shows the plugin integration system 102 performing an act 408 of executing a download API operation. For example, in response to a function call from the large language model via the content management system plugin, the plugin integration system 102 downloads (e.g., retrieves a copy of) one or more content items from the content management system. To illustrate, the plugin integration system 102 downloads the content items containing quarterly revenue information.

Continuing on, FIG. 4 shows the plugin integration system 102 performing an act 410 of executing a content synthesis API operation. For example, in response to a function call from the large language model via the content management system plugin, the plugin integration system 102 collects and combines content from one or more content items. For instance, the plugin integration system 102 locates information relevant to the large language model prompt in two different content items, and synthesizes the relevant information for the large language model. To illustrate, the plugin integration system 102 synthesizes multiple pieces of information from multiple content items containing quarterly revenue information.

Additionally, FIG. 4 shows the plugin integration system 102 performing an act 412 of executing a copy API operation. For example, in response to a function call from the large language model via the content management system plugin, the plugin integration system 102 provides a copy of the one or more content items (or of portions of the one or more content items) to the large language model. To illustrate, the plugin integration system 102 copies the pieces of information from the content items containing quarterly revenue information.

Furthermore, FIG. 4 shows the plugin integration system 102 performing an act 414 of executing a summarize content API operation. For example, in response to a function call from the large language model via the content management system plugin, the plugin integration system 102 summarizes content from the one or more content items. To illustrate, the plugin integration system 102 generates a summary of the information from the content items containing quarterly revenue information.

Moreover, FIG. 4 shows the plugin integration system 102 performing an act 416 of executing a special effects API operation. For example, in response to a function call from the large language model via the content management system plugin, the plugin integration system 102 utilizes a special effects function to modify content within one or more content items. To illustrate, the plugin integration system 102 generates a graph depicting metrics within the information from the content items containing quarterly revenue information.

In addition, FIG. 4 shows the plugin integration system 102 performing an act 418 of executing a combine content API operation. For example, in response to a function call from the large language model via the content management system plugin, the plugin integration system 102 aggregates content from multiple content items for inclusion in a new content item. To illustrate, the plugin integration system 102 combines the information from the content items containing quarterly revenue information with the graph depicting the metrics.

Also, FIG. 4 shows the plugin integration system 102 performing an act 420 of executing a create new content item API operation. For example, in response to a function call from the large language model via the content management system plugin, the plugin integration system 102 generates a content item. For instance, the plugin integration system 102 utilizes a template file to generate a new file and adds the aggregated content (e.g., from act 418) to the new file. To illustrate, the plugin integration system 102 generates a pdf that includes the combined information (e.g., including the graph and other information about the quarterly revenue).

Moreover, FIG. 4 shows the plugin integration system 102 performing an act 422 of executing an upload API operation. For example, in response to a function call from the large language model via the content management system plugin, the plugin integration system 102 stores the content item (e.g., the new file from act 420) within the content management system. To illustrate, the user enters a follow-up prompt of “save this pdf to my account” and the plugin integration system 102 uploads the pdf document to a portion of the content management system accessible to the user.

Furthermore, FIG. 4 shows the plugin integration system 102 performing an act 424 of executing a share API operation. For example, in response to a function call from the large language model via the content management system plugin, the plugin integration system 102 provides the content item for display via the client device, provides the content item for display via one or more additional client devices, and/or transmits the content item to another system. To illustrate, the user enters another prompt of “share this pdf with my financial team” and the plugin integration system 102 sends the pdf document to other user accounts within the content management system.

In some embodiments, the plugin integration system 102 executes other API operations. For example, the plugin integration system 102 can execute a move API operation, by which the plugin integration system 102 relocates a content item (e.g., across directories in a folder hierarchy, across user accounts in the content management system, etc.). As another example, the plugin integration system 102 can execute an edit API operation, by which the plugin integration system 102 modifies a content item (e.g., updating information within the content item). For another example, the plugin integration system 102 can execute a team-based API operation, by which the plugin integration system 102 interacts with content items across multiple collaborating user accounts of the content management system. To illustrate, the plugin integration system 102 notifies a collaborating user account that additional information is needed to prepare the quarterly revenue summary document. Upon receiving the additional information from the collaborating user account, the plugin integration system 102 synthesizes and combines the additional information into the pdf document.

In some implementations, the plugin integration system 102 performs some of these API operations in conjunction with the large language model. For example, in some cases, the large language model executes some of the API operations while the plugin integration system 102 executes others of the API operations. To illustrate an example, the plugin integration system 102 performs the act 408 of executing a download API operation, and utilizes the large language model to perform the act 410 of executing a content synthesis API operation. Moreover, in some implementations, the plugin integration system 102 performs some of the API operations in conjunction with the large language model and with a third-party system. For instance, in some cases, the third-party system executes some of the API operations (e.g., the act 416 of executing a special effects API operation).

As noted above, the plugin integration system 102 can perform additional API operations. Moreover, the layered set depicted in FIG. 4 is for illustrative purposes only. The plugin integration system 102 can perform more, fewer, or different API operations. Additionally, in some embodiments, the plugin integration system 102 performs the API operations shown in FIG. 4 in differing orders or in combination with additional API operations. In some implementations, a third-party system performs some of the API operations to support the plugin integration system 102 and the large language model in interacting with content items to answer a large language model prompt.

Moreover, in some implementations, the plugin integration system 102 performs one or more API operations in reverse (e.g., to undo a prior action). For instance, the plugin integration system 102 executes a reverse version of an API operation on a content item to undo a prior action associated with a function call. To illustrate, the plugin integration system 102 receives a request to perform a reverse version of an API operation. In response, the plugin integration system 102 can execute the reverse version of the API operation on the content item to undo a prior action associated with the function call. To illustrate further, the plugin integration system 102 receives a reverse set of function calls requesting performance of a reverse of an ordered series of API operations on one or more content items. The plugin integration system 102 can execute the reverse of the ordered series of API operations on the one or more content items in response to the reverse set of function calls. For example, the user may want to undo the upload of the pdf document of quarterly revenue information. The user may enter a prompt “undo the save pdf to my account” and the plugin integration system 102 can execute a reverse of the upload API operation to remove the pdf from the user account on the content management system.

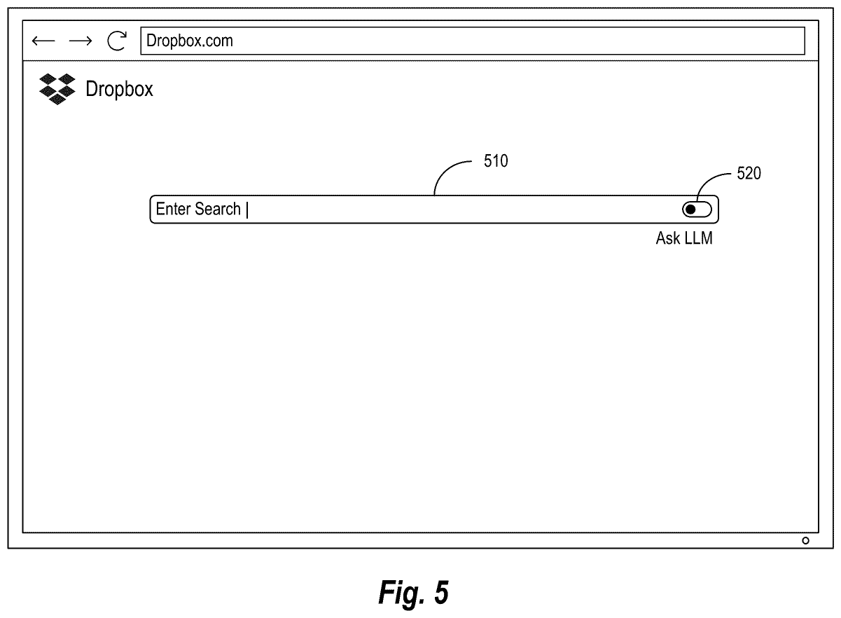

As discussed, in some embodiments, the plugin integration system 102 provides a selectable option to treat a user-entered prompt as a large language model prompt. For instance, FIG. 5 illustrates the plugin integration system 102 providing a user interface element for initiating a large language model prompt in accordance with one or more embodiments.

In particular, FIG. 5 shows the plugin integration system 102 providing a graphical user interface for display via a client device. The graphical user interface includes a view of a web application for accessing a content management system. In particular, the graphical user interface includes a query interface 510 for entering a prompt. In some implementations, the plugin integration system 102 provides a user interface element 520 (e.g., a toggle button) for display via the user interface on the client device. For example, the plugin integration system 102 provides the user interface element 520 for initiating a large language model prompt. To illustrate, while a user may enter a prompt for the content management system (e.g., a search query for a content item), the user may choose to send the prompt to the large language model by interacting with the user interface element 520 (e.g., switching the toggle button to “on”).

To further illustrate, the plugin integration system 102 can receive a user interaction with the user interface element 520. In some cases, the plugin integration system 102 detects that the user interaction indicates a large language model prompt. The plugin integration system 102 can provide the large language model prompt to the large language model. For example, and as described above, the plugin integration system 102 sends the prompt to the large language model to interact with content items via the content management system plugin.

To illustrate, a user may enter a prompt “generate a tutorial about the software development process from info in my folder ‘Dev Tips and Tricks,’” and select the option to ask the large language model. As described above, the plugin integration system 102 can utilize, via the content management system plugin, the large language model to locate content items in the folder “Dev Tips and Tricks” on the user's content management system account. Furthermore, the plugin integration system 102 can utilize the large language model to identify content items relevant to the software development process, synthesize and summarize the relevant information, and generate a new content item that has the tutorial. Continuing this illustration, the user may enter an additional prompt “share this tutorial with my team.” The plugin integration system 102 can send the new content item to associated user accounts on the user's team by performing an API operation to determine team member accounts within the content management system and performing another API operation to send the content item to the team member accounts (e.g., using a file sharing function native to the content management system and/or another file sharing function).

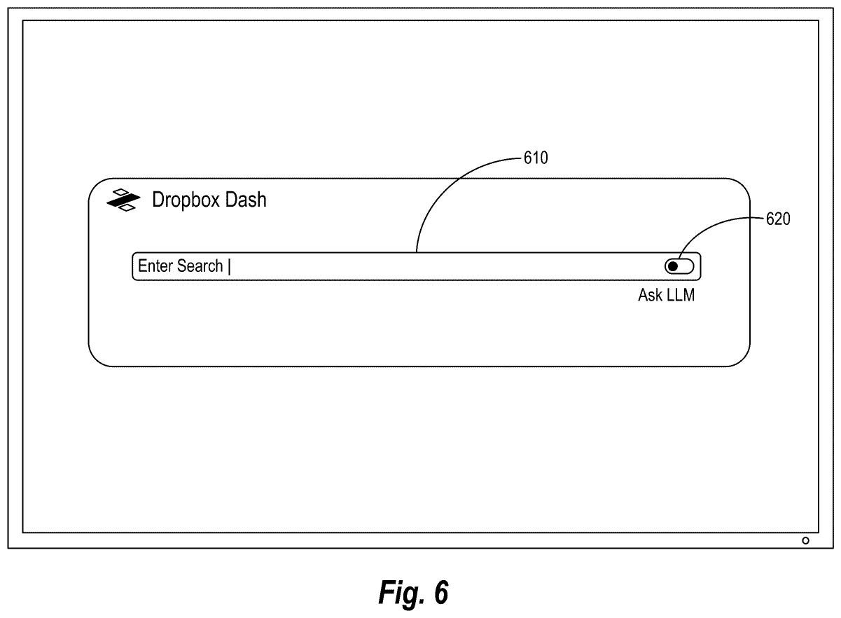

As just discussed, in some embodiments, the plugin integration system 102 provides a selectable option to treat a user-entered prompt as a large language model prompt. For instance, FIG. 6 illustrates another example of the plugin integration system 102 providing a user interface element for initiating a large language model prompt in accordance with one or more embodiments.

In particular, FIG. 6 shows the plugin integration system 102 providing a graphical user interface for display via a client device. The graphical user interface includes a view of an AI-powered assistant for accessing information, including content items within a content management system. In particular, the graphical user interface includes a query interface 610 for entering a prompt. In some implementations, the plugin integration system 102 provides a user interface element 620 (e.g., a toggle button) for display via the user interface on the client device. For example, the plugin integration system 102 provides the user interface element 620 for initiating a large language model prompt. The plugin integration system 102 can utilize the AI-powered assistant to integrate a content management system plugin with a large language model, and utilize the large language model to interact with content items.

For example, similar to the description above in connection with FIG. 5, the plugin integration system 102 can receive a user query and a user interaction indicating that the query is a large language model query. The plugin integration system 102 can proceed to utilize the large language model, via the content management system plugin, to interact with content items on the content management system.

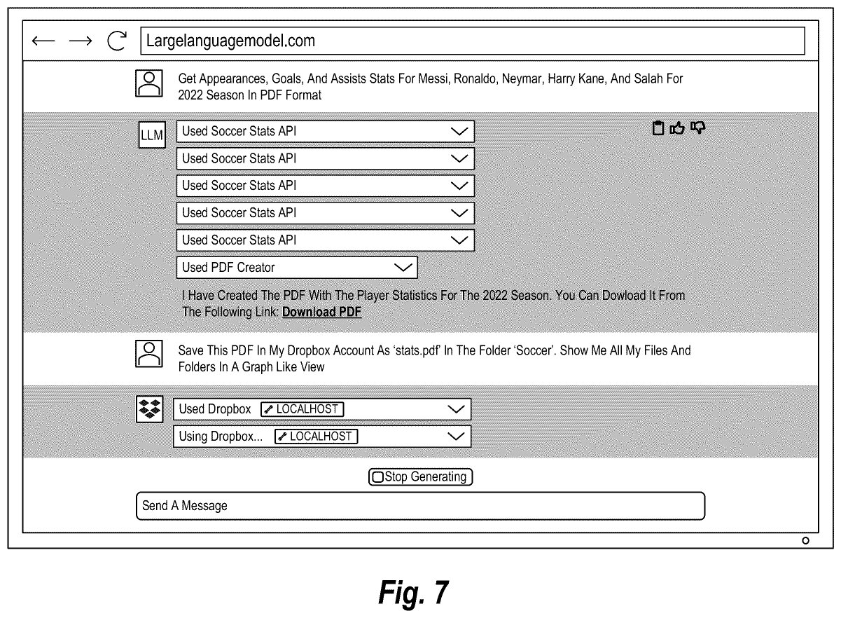

As discussed above, in some embodiments, the plugin integration system 102 utilizes a large language model to interact with content items on a content management system. For instance, FIG. 7 illustrates the plugin integration system 102 interfacing with a large language model to generate responses to prompts in accordance with one or more embodiments.

Specifically, FIG. 7 shows a user interface of the large language model receiving prompts from the plugin integration system 102 via the content management system plugin. To illustrate, a user enters a prompt “get appearances, goals, and assist stats for Messi, Ronaldo, Neymar, Harry Kane, and Salah for 2022 season in pdf format.” In response, the plugin integration system 102 utilizes the large language model (via the content management system plugin) to access the requested statistics for these players and generate a pdf containing the information. As further illustrated in FIG. 7, the user enters a follow-up prompt “save this pdf in my Dropbox account as ‘stats.pdf’ in the folder ‘Soccer’. Show me all my files and folders in a graph like view.” In response, the plugin integration system 102 utilizes the large language model to upload the generated pdf, with the requested filename, to a Soccer folder in the user's account on the content management system.

In particular, and as discussed, the plugin integration system 102 can utilize API operations native to the content management system and/or API operations from third-party systems. For example, in some implementations, the plugin integration system 102 utilizes one or more third-party API operations to retrieve data and/or perform operations on content items (e.g., in FIG. 7, the plugin integration system 102 utilizes “Soccer Stats API” to retrieve data containing the requested soccer statistics). Moreover, in some implementations, the plugin integration system 102 utilizes one or more API operations native to the content management system to retrieve data and/or perform operations on the content items (e.g., in FIG. 7, the plugin integration system 102 utilizes an API called “Dropbox” to upload the generated pdf to the user account's portion of the content management system).

As illustrated in FIG. 7, the large language model can show the user which API operations are executed during the process of generating the content item and storing the content item to the content management system. This can give the user some insight to the processes of the large language model and the plugin integration system 102 as they generate responses to the user queries. In addition, the user interface includes a “stop generating” option that is selectable during execution of one or more API operations to stop the process. Indeed, if a user notices that the large language model is calling API operations that are leading to an undesired result (as indicated in the transparent view of API operations performed in sequence), the plugin integration system 102 can receive a selection of the “stop generating” option to stop the process for entering a new query to clarify some terms and try again. In some cases, the plugin integration system 102 can receive input (either via a prompt or a specific selection of an option in the user interface) to indicate to the large language model which API operation to use for a particular step of the workflow process for generating a response/output to a prompt.

As demonstrated by FIG. 7, in some implementations, the plugin integration system 102 generates a new content item by executing a first API operation associated with the content management system plugin (e.g., a content generation API operation). Additionally, the plugin integration system 102 can store the new content item within the content management system by executing a second API operation associated with the content management system plugin (e.g., an upload API operation).

In some embodiments, the plugin integration system 102 provides administrator-level permissions for accessing the content management system plugin. For example, the plugin integration system 102 provides an administrator or senior-level account an option to determine whether other user accounts within an organizational ontology can access and utilize the content management system plugin.

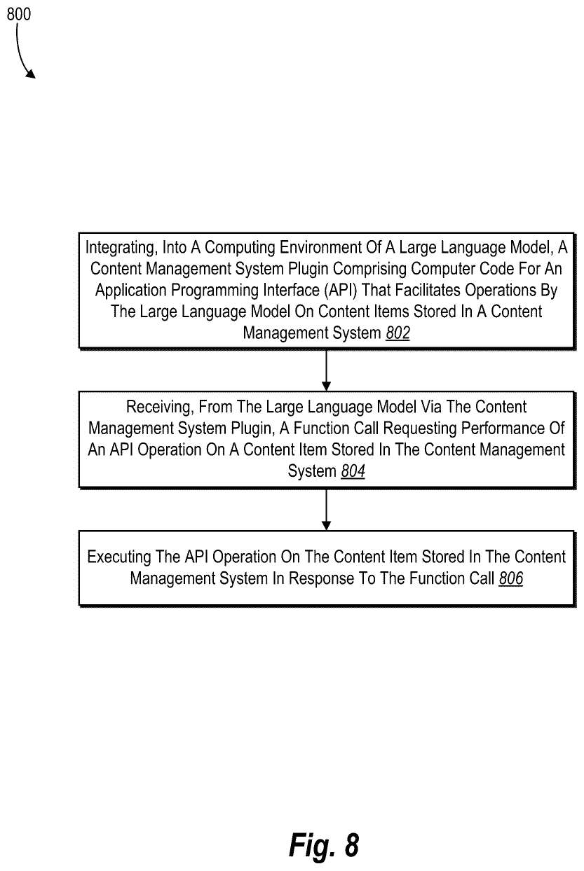

FIGS. 1-7, the corresponding text, and the examples provide a number of different methods, systems, devices, and non-transitory computer-readable media of the plugin integration system 102. In addition to the foregoing, one or more embodiments can also be described in terms of flowcharts comprising acts for accomplishing a particular result, as shown in FIG. 8. FIG. 8 may be performed with more or fewer acts. Further, the acts may be performed in differing orders. Additionally, the acts described herein may be repeated or performed in parallel with one another or parallel with different instances of the same or similar acts.

As mentioned, FIG. 8 illustrates a flowchart of a series of acts 800 for integrating and utilizing a content management system plugin with a large language model in accordance with one or more implementations. While FIG. 8 illustrates acts according to one implementation, alternative implementations may omit, add to, reorder, and/or modify any of the acts shown in FIG. 8. The acts of FIG. 8 can be performed as part of a method. Alternatively, a non-transitory computer-readable storage medium can comprise instructions that, when executed by one or more processors, cause a computing device to perform the acts of FIG. 8. In some implementations, a system performs the acts of FIG. 8.

As shown in FIG. 8, the series of acts 800 includes an act 802 of integrating, into a computing environment of a large language model, a content management system plugin comprising computer code for an application programming interface (API) that facilitates operations by the large language model on content items stored in a content management system, an act 804 of receiving, from the large language model via the content management system plugin, a function call requesting performance of an API operation on a content item stored in the content management system, and an act 806 of executing the API operation on the content item stored in the content management system in response to the function call.

In particular, in some implementations, the act 802 includes integrating, into a computing environment of a large language model, a content management system plugin comprising computer code for an application programming interface (API) that facilitates operations by the large language model on content items stored in a content management system, the act 804 includes receiving, from the large language model via the content management system plugin, a function call requesting performance of an API operation on a content item stored in the content management system, and the act 806 includes executing the API operation on the content item stored in the content management system in response to the function call from the content management system plugin integrated within the large language model. In some implementations, the act 802 includes integrating, into a computing environment of a large language model, a content management system plugin comprising computer code for an application programming interface (API), wherein the content management system plugin facilitates operations by the large language model on content items stored in a content management system. In some implementations, the act 804 includes receiving, via the content management system plugin, a function call requesting performance of an API operation by the large language model on a content item stored in the content management system. In some implementations, the act 806 includes executing the API operation on the content item stored in the content management system in response to the function call from the large language model via the content management system plugin.

For example, in some implementations, the series of acts 800 includes integrating the content management system plugin by installing the computer code within the computing environment of the large language model to make the application programming interface available to the large language model.

In addition, in some implementations, the series of acts 800 includes receiving, from the large language model via the content management system plugin, an additional function call requesting performance of an additional API operation on the content item stored in the content management system; and executing the additional API operation on the content item in response to the additional function call.

Moreover, in some implementations, the series of acts 800 includes executing the API operation on the content item stored in the content management system by executing at least one of a search operation, a metadata access operation, a download operation, a copying operation, a moving operation, an editing operation, a content generation operation, a sharing operation, or an upload operation. In some implementations, the series of acts 800 includes executing the API operation on the content item stored in the content management system by executing one or more of a search operation, a metadata access operation, a download operation, a copying operation, a moving operation, an editing operation, a content generation operation, a sharing operation, or an upload operation.

Furthermore, in some implementations, the series of acts 800 includes executing the API operation on the content item stored in the content management system by executing a team-based API operation on a plurality of content items stored across a plurality of user accounts of the content management system. In some implementations, the series of acts 800 includes executing the API operation on the content item stored in the content management system by: executing a team-based API operation on the content item stored for a first user account of the content management system; and executing the team-based API operation on an additional content item stored for a second user account of the content management system.

Additionally, in some implementations, the series of acts 800 includes generating, by executing a first API operation associated with the content management system plugin, a new content item comprising information from at least a portion of the content items stored in the content management system; and storing, by executing a second API operation associated with the content management system plugin, the new content item within the content management system. In some implementations, the series of acts 800 includes generating, by executing a content generation API operation associated with the content management system plugin, a new content item comprising information from at least a portion of the content items stored in the content management system; and storing, by executing an upload API operation associated with the content management system plugin, the new content item within the content management system.

Moreover, in some implementations, the series of acts 800 includes executing a reverse version of the API operation on the content item to undo a prior action associated with the function call. In some implementations, the series of acts 800 includes receiving, from the computing environment of the large language model, a request to perform a reverse version of the API operation; and executing the reverse version of the API operation on the content item to undo a prior action associated with the function call. In some implementations, the series of acts 800 includes receiving, from the large language model via the content management system plugin, a reverse set of function calls requesting performance of a reverse of the ordered series of API operations on the one or more content items; and executing the reverse of the ordered series of API operations on the one or more content items in response to the reverse set of function calls.

Furthermore, in some implementations, the series of acts 800 includes providing, for display via a user interface of a client device, a toggle element for initiating a large language model prompt; receiving a user interaction with the toggle element; and providing, to the large language model, the large language model prompt indicating operations associated with the content items stored in the content management system. In some implementations, the series of acts 800 includes providing, for display via a client device, a user interface element for initiating a large language model prompt; receiving a user interaction with the user interface element; and providing, to the large language model, the large language model prompt indicating operations for one or more of the content items stored in the content management system.

In addition, in some implementations, the series of acts 800 includes receiving, via the content management system plugin, one or more function calls requesting performance of an ordered series of API operations by the large language model on one or more content items stored in the content management system. In some implementations, the series of acts 800 includes receiving, from the large language model via the content management system plugin, a set of function calls requesting performance of an ordered series of API operations on one or more content items stored in the content management system; and executing the ordered series of API operations on the one or more content items in response to the set of function calls.

Moreover, in some implementations, the series of acts 800 includes receiving, from at least one of the large language model or a third-party system, an additional function call requesting performance of an additional API operation on an additional content item modified by execution of a third-party API operation at the third-party system; and executing the additional API operation on the additional content item in response to the additional function call. In some implementations, the series of acts 800 includes receiving, from the large language model via the content management system plugin, an additional function call requesting performance of an additional API operation on the content item after the content item is modified by execution of a third-party API operation at a third-party system; and executing the additional API operation on the content item in response to the additional function call.

Embodiments of the present disclosure may comprise or utilize a special purpose or general purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions from a non-transitory computer-readable medium (e.g., memory) and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or generators and/or other electronic devices. When information is transferred, or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface generator (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general purpose computer, special purpose computer, or special purpose processing device to perform a certain function or group of functions. In some embodiments, computer-executable instructions are executed by a general purpose computer to turn the general purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program generators may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), a web service, Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 9 illustrates a block diagram of an example computing device 900 that may be configured to perform one or more of the processes described above. One will appreciate that one or more computing devices, such as the computing device 900, may represent the computing devices described above (e.g., the server device(s) 106, the client device 108, the client device 202). In one or more embodiments, the computing device 900 may be a mobile device (e.g., a mobile telephone, a smartphone, a PDA, a tablet, a laptop, a camera, a tracker, a watch, a wearable device, etc.). In some embodiments, the computing device 900 may be a non-mobile device (e.g., a desktop computer or another type of client device). Further, the computing device 900 may be a server device that includes cloud-based processing and storage capabilities.

As shown in FIG. 9, the computing device 900 can include one or more processor(s) 902, memory 904, a storage device 906, input/output interfaces 908 (or “I/O interfaces 908”), and a communication interface 910, which may be communicatively coupled by way of a communication infrastructure (e.g., bus 912). While the computing device 900 is shown in FIG. 9, the components illustrated in FIG. 9 are not intended to be limiting. Additional or alternative components may be used in other embodiments. Furthermore, in certain embodiments, the computing device 900 includes fewer components than those shown in FIG. 9. Components of the computing device 900 shown in FIG. 9 will now be described in additional detail.

In particular embodiments, the processor(s) 902 includes hardware for executing instructions, such as those making up a computer program. As an example, and not by way of limitation, to execute instructions, the processor(s) 902 may retrieve (or fetch) the instructions from an internal register, an internal cache, memory 904, or a storage device 906 and decode and execute them.

The computing device 900 includes the memory 904, which is coupled to the processor(s) 902. The memory 904 may be used for storing data, metadata, and programs for execution by the processor(s). The memory 904 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 904 may be internal or distributed memory.

The computing device 900 includes the storage device 906 for storing data or instructions. As an example, and not by way of limitation, the storage device 906 can include a non-transitory storage medium described above. The storage device 906 may include a hard disk drive (“HDD”), flash memory, a Universal Serial Bus (“USB”) drive or a combination these or other storage devices.

As shown, the computing device 900 includes one or more I/O interfaces 908, which are provided to allow a user to provide input to (such as user strokes), receive output from, and otherwise transfer data to and from the computing device 900. These I/O interfaces 908 may include a mouse, keypad or a keyboard, a touch screen, camera, optical scanner, network interface, modem, other known I/O devices or a combination of such I/O interfaces 908. The touch screen may be activated with a stylus or a finger.

The I/O interfaces 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 908 are configured to provide graphical data to a display for presentation to a user. The graphical data may be representative of one or more graphical user interfaces and/or any other graphical content as may serve a particular implementation.

The computing device 900 can further include a communication interface 910. The communication interface 910 can include hardware, software, or both. The communication interface 910 provides one or more interfaces for communication (such as, for example, packet-based communication) between the computing device and one or more other computing devices or one or more networks. As an example, and not by way of limitation, communication interface 910 may include a network interface controller (“NIC”) or network adapter for communicating with an Ethernet or other wire-based network or a wireless NIC (“WNIC”) or wireless adapter for communicating with a wireless network, such as a WI-FI. The computing device 900 can further include the bus 912. The bus 912 can include hardware, software, or both that connects components of computing device 900 to each other.

Each of the components of the plugin integration system 102 can include software, hardware, or both. For example, the components of the plugin integration system 102 can include one or more instructions stored on a computer-readable storage medium and executable by processors of one or more computing devices, such as a client device or server device. When executed by the one or more processors, the computer-executable instructions of the plugin integration system 102 can cause the computing device(s) to perform the methods described herein. Alternatively, the components of the plugin integration system 102 can include hardware, such as a special purpose processing device to perform a certain function or group of functions. Alternatively, the components of the plugin integration system 102 can include a combination of computer-executable instructions and hardware.

Furthermore, the components of the plugin integration system 102 may, for example, be implemented as one or more operating systems, as one or more stand-alone applications, as one or more modules of an application, as one or more plug-ins, as one or more library functions or functions that may be called by other applications, and/or as a cloud-computing model. Thus, the components of the plugin integration system 102 may be implemented as a stand-alone application, such as a desktop or mobile application. Furthermore, the components of the plugin integration system 102 may be implemented as one or more web-based applications hosted on a remote server. The components of the plugin integration system 102 may also be implemented in a suite of mobile device applications or “apps.”

FIG. 10 is a schematic diagram illustrating a network environment 1000 within which one or more implementations of the plugin integration system 102 can be implemented. For example, the plugin integration system 102 may be part of a content management system 1002 (e.g., the content management system 104). The content management system 1002 may generate, store, manage, receive, and send digital content (such as digital content items). For example, the content management system 1002 may send and receive digital content to and from client device(s) 1006 by way of a network 1004. In particular, the content management system 1002 can store and manage a collection of digital content. The content management system 1002 can manage the sharing of digital content between computing devices associated with a plurality of users. For instance, the content management system 1002 can facilitate a user sharing digital content with another user of the content management system 1002.

In particular, the content management system 1002 can manage synchronizing digital content across multiple client devices 1006 associated with one or more users. For example, a user may edit digital content using client device 1006. The content management system 1002 can cause client device 1006 to send the edited digital content to the content management system 1002. The content management system 1002 then synchronizes the edited digital content on one or more additional computing devices.

In addition to synchronizing digital content across multiple devices, one or more implementations of the content management system 1002 can provide an efficient storage option for users that have large collections of digital content. For example, the content management system 1002 can store a collection of digital content on the content management system 1002, while the client device 1006 only stores reduced-sized versions of the digital content. A user can navigate and browse the reduced-sized versions (e.g., a thumbnail of a digital image) of the digital content on the client device 1006. In particular, one way in which a user can experience digital content is to browse the reduced-sized versions of the digital content on the client device 1006.

Another way in which a user can experience digital content is to select a reduced-size version of digital content to request the full- or high-resolution version of digital content from the content management system 1002. In particular, upon a user selecting a reduced-sized version of digital content, the client device 1006 sends a request to the content management system 1002 requesting the digital content associated with the reduced-sized version of the digital content. The content management system 1002 can respond to the request by sending the digital content to the client device 1006. The client device 1006, upon receiving the digital content, can then present the digital content to the user. In this way, a user can have access to large collections of digital content while minimizing the amount of resources used on the client device 1006.

The client device 1006 may be a desktop computer, a laptop computer, a tablet computer, a personal digital assistant (PDA), an in- or out-of-car navigation system, a smart TV, a virtual reality (VR) or augmented reality (AR) device, a handheld device, a wearable device, a smartphone or other cellular or mobile phone, or a mobile gaming device, other mobile device, or other suitable computing devices. The client device 1006 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.) to access and view content over the network 1004.

The network 1004 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which the client device(s) 1006 may access the content management system 1002.

The use in the foregoing description and in the appended claims of the terms “first,” “second,” “third,” etc., is not necessarily to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget, and not necessarily to connote that the second widget has two sides.

In the foregoing description, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with fewer or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
integrating, into a computing environment of a large language model, a content management system plugin comprising computer code for an application programming interface (API), wherein the content management system plugin facilitates operations by the large language model on content items stored in a content management system;
receiving, from the large language model via the content management system plugin, a function call requesting performance of an API operation on a content item stored in the content management system; and
executing the API operation on the content item stored in the content management system in response to the function call from the content management system plugin integrated within the large language model.

2. The computer-implemented method of claim 1, wherein integrating the content management system plugin comprises installing the computer code within the computing environment of the large language model to make the application programming interface available to the large language model.

3. The computer-implemented method of claim 1, further comprising:
receiving, from the large language model via the content management system plugin, an additional function call requesting performance of an additional API operation on the content item stored in the content management system; and
executing the additional API operation on the content item in response to the additional function call.

4. The computer-implemented method of claim 1, wherein executing the API operation on the content item stored in the content management system comprises executing at least one of a search operation, a metadata access operation, a download operation, a copying operation, a moving operation, an editing operation, a content generation operation, a sharing operation, or an upload operation.

5. The computer-implemented method of claim 1, wherein executing the API operation on the content item stored in the content management system comprises executing a team-based API operation on a plurality of content items stored across a plurality of user accounts of the content management system.

6. The computer-implemented method of claim 1, further comprising:
generating, by executing a first API operation associated with the content management system plugin, a new content item comprising information from at least a portion of the content items stored in the content management system; and
storing, by executing a second API operation associated with the content management system plugin, the new content item within the content management system.

7. The computer-implemented method of claim 1, further comprising executing a reverse version of the API operation on the content item to undo a prior action associated with the function call.

8. A system comprising:
at least one processor; and
at least one non-transitory computer-readable storage medium comprising instructions that, when executed by the at least one processor, cause the system to:
integrate, into a computing environment of a large language model, a content management system plugin comprising computer code for an application programming interface (API), wherein the content management system plugin facilitates operations by the large language model on content items stored in a content management system;
receive, via the content management system plugin, a function call requesting performance of an API operation by the large language model on a content item stored in the content management system; and
execute the API operation on the content item stored in the content management system in response to the function call from the content management system plugin integrated within the large language model.

9. The system of claim 8, wherein the at least one non-transitory computer-readable storage medium further comprises instructions that, when executed by the at least one processor, cause the system to:
provide, for display via a user interface of a client device, a toggle element for initiating a large language model prompt;
receive a user interaction with the toggle element; and
provide, to the large language model, the large language model prompt indicating operations associated with the content items stored in the content management system.

10. The system of claim 8, wherein the at least one non-transitory computer-readable storage medium further comprises instructions that, when executed by the at least one processor, cause the system to receive, via the content management system plugin, one or more function calls requesting performance of an ordered series of API operations by the large language model on one or more content items stored in the content management system.

11. The system of claim 8, wherein the at least one non-transitory computer-readable storage medium further comprises instructions that, when executed by the at least one processor, cause the system to execute the API operation on the content item stored in the content management system by executing one or more of a search operation, a metadata access operation, a download operation, a copying operation, a moving operation, an editing operation, a content generation operation, a sharing operation, or an upload operation.

12. The system of claim 8, wherein the at least one non-transitory computer-readable storage medium further comprises instructions that, when executed by the at least one processor, cause the system to:
receive, from at least one of the large language model or a third-party system, an additional function call requesting performance of an additional API operation on an additional content item modified by execution of a third-party API operation at the third-party system; and
execute the additional API operation on the additional content item in response to the additional function call.

13. The system of claim 8, wherein the at least one non-transitory computer-readable storage medium further comprises instructions that, when executed by the at least one processor, cause the system to:
generate, by executing a content generation API operation associated with the content management system plugin, a new content item comprising information from at least a portion of the content items stored in the content management system; and
store, by executing an upload API operation associated with the content management system plugin, the new content item within the content management system.

14. The system of claim 8, wherein the at least one non-transitory computer-readable storage medium further comprises instructions that, when executed by the at least one processor, cause the system to:
receive, from the computing environment of the large language model, a request to perform a reverse version of the API operation; and
execute the reverse version of the API operation on the content item to undo a prior action associated with the function call.

15. A non-transitory computer-readable storage medium comprising instructions that, when executed by at least one processor, cause a computing device to:
integrate, into a computing environment of a large language model, a content management system plugin comprising computer code for an application programming interface (API), wherein the content management system plugin facilitates operations by the large language model on content items stored in a content management system;
receive, from the large language model via the content management system plugin, a function call requesting performance of an API operation on a content item stored in the content management system; and
execute the API operation on the content item stored in the content management system in response to the function call from the large language model via the content management system plugin.

16. The non-transitory computer-readable storage medium of claim 15, further comprising instructions that, when executed by the at least one processor, cause the computing device to:
provide, for display via a client device, a user interface element for initiating a large language model prompt;
receive a user interaction with the user interface element; and
provide, to the large language model, the large language model prompt indicating operations for one or more of the content items stored in the content management system.

17. The non-transitory computer-readable storage medium of claim 15, further comprising instructions that, when executed by the at least one processor, cause the computing device to:
receive, from the large language model via the content management system plugin, a set of function calls requesting performance of an ordered series of API operations on one or more content items stored in the content management system; and
execute the ordered series of API operations on the one or more content items in response to the set of function calls.

18. The non-transitory computer-readable storage medium of claim 17, further comprising instructions that, when executed by the at least one processor, cause the computing device to:
receive, from the large language model via the content management system plugin, a reverse set of function calls requesting performance of a reverse of the ordered series of API operations on the one or more content items; and
execute the reverse of the ordered series of API operations on the one or more content items in response to the reverse set of function calls.

19. The non-transitory computer-readable storage medium of claim 15, further comprising instructions that, when executed by the at least one processor, cause the computing device to execute the API operation on the content item stored in the content management system by:
executing a team-based API operation on the content item stored for a first user account of the content management system; and
executing the team-based API operation on an additional content item stored for a second user account of the content management system.

20. The non-transitory computer-readable storage medium of claim 15, further comprising instructions that, when executed by the at least one processor, cause the computing device to:
receive, from the large language model via the content management system plugin, an additional function call requesting performance of an additional API operation on the content item after the content item is modified by execution of a third-party API operation at a third-party system; and
execute the additional API operation on the content item in response to the additional function call.
